(19) United States
(12) Patent Application Publication
(10) Pub. No.: US 2005/0070653 A1
(43) Pub. Date: Mar. 31, 2005

(54) High-solids aqueous dispersions their preparation and use

(75) Inventors: Gregor Apitz, Eppstein (DE); Ivan Cabrera, Dreieich (DE)

Correspondence Address: CONNOLLY BOVE LODGE & HUTZ, LLP, P O BOX 2207, WILMINGTON, DE, 19899, US

(73) Assignee: Celanese Emulsions GmbH, Kronberg/Ts. (DE)

(21) Appl. No.: 10/946,958

(22) Filed: Sep. 22, 2004

(30) Foreign Application Priority Data
Sep. 26, 2003 (DE) DE 103 44 801.2

(51) Int. Cl. C08L 1/00

(52) U.S. Cl. 524/417; 524/556; 524/563

(57) ABSTRACT

High-solids aqueous polymer dispersions, their preparation and use A description is given of an aqueous polymer dispersion derived from at least one ethylenically unsaturated monomer and with a solids content of at least 60% by weight, based on the polymer dispersion. The polymer dispersion comprises at least one salt of a phosphorus acid. The preparation takes place by free-radical emulsion polymerization of at least one ethylenically unsaturated monomer in aqueous phase in the presence of at least one emulsifier, at least one initiator and at least one salt of a phosphorus acid. With the process it is possible to prepare aqueous polymer dispersions having a high solids content in combination with a low viscosity, these polymer dispersions being suitable for formulating adhesives.

The invention relates to polymer dispersions having a high solids content and a low viscosity, to a process for preparing them and to their use, particularly as flooring adhesives or as jointing compounds.

Aqueous polymer dispersions are employed in a multiplicity of fields; for example, as base material for paints, varnishes and adhesives, as laminating compositions for paper or as an additive to building materials.

The majority of dispersions have a solids content of from 45% to 60% by weight. Advantages of such dispersions over their lower-solids counterparts are considered to include reduced film drying times and lower transport costs.

With the increasing solids content, however, there is a drastic rise in viscosity which during the polymerization may lead not only to the formation of specks but even to complete coagulation of the dispersion.

The prior art discloses a number of processes for preparing highly concentrated polymer dispersions of relatively low viscosity. Here, generally speaking, monomodal or multimodal seed latices are employed which serve as a basis for the polymerization of at least one monomer, or emulsion polymerization processes are employed which require compliance with a multiplicity of conditions.

In the preparation of highly concentrated polymer dispersions the aim is for a broad and/or multimodal distribution of particle diameters, so that the polymer particles fill the available space with maximum efficiency, approximating for example to a closest spherical packing.

In the case of the known preparation processes a frequent difficulty to be overcome is that the diameters of the particles initially present or formed intermediately converge as the process progresses.

EP-A-784,060 discloses a copolymer latex which has a solids content of at least 67% by weight and a viscosity at room temperature of not more than 2000 cP. This copolymer latex is obtained by polymerizing carboxyl-functional monomers with further ethylenically unsaturated monomers in the presence of emulsifier, with further emulsifier being added at a monomer conversion of from 40% to 60%.

WO-A 96/11,234 discloses an aqueous polymer dispersion having solids contents of at least 60% by weight and at least bimodal particle distribution. That dispersion is prepared by including in the initial charge a seed latex onto which free-radically polymerizable monomers are grafted, forming large, nonspherical particles.

EP-A-81,083 discloses a process in which two polymer lattices differing in average particle size are included in the initial charge and subsequently the monomers are polymerized.

EP-A-554,832 describes the preparation of highly concentrated polymer dispersions having a solids content of 40-70% by weight by copolymerizing alkyl acrylates and polar comonomers copolymerizable therewith, the copolymerization taking place in the presence of a hydrophobic polymer and of a copolymerizable emulsifier.

EP-A-567,811, EP-A-567,819, EP-A-568,831 and EP-A-568,834 disclose processes for preparing dispersions having high solids contents, requiring in each case compliance with a series of complicated process steps.

In the case of EP-A 567,811 at least some of an extremely finely divided latex is included in the initial charge and the monomers are polymerized in compliance with a plurality of highly complex process conditions.

In EP-A-567,819 a seed latex mixture comprising latex particles up to 400 nm in size and latex particles up to 100 nm in size is included in the initial charge and the monomers are polymerized in compliance with highly complex process conditions.

EP-A-567,831 describes a process for preparing highly concentrated dispersions by including a coarsely particulate latex in the initial charge and metering in a finely divided latex and the monomers.

EP-A-568,834, finally, describes a process in which two seed lattices, of which one includes both coarse and fine polymer particles, are included in the initial charge and the monomers are metered in.

The known processes for preparing highly concentrated dispersions share the feature of relatively complex measures, often in combination with inconvenient seed latex techniques.

In one group of the known processes for preparing highly concentrated polymer dispersions a plurality of seed latices differing in particle size are used, and are added at different phases in the polymerization process.

In another group of known processes, a seed latex is produced in situ and the nucleation of secondary and further particle populations is initiated later on in the polymerization process.

On the basis of this prior art the present invention provides a process which allows virtually speck-free and coagulum-free dispersions having a high solids content to be prepared in a simple manner.

The present invention further provides a process for preparing polymer dispersions having a high solids content that does not involve the use of seed latex.

A further object of the present invention is to provide virtually speck- and coagulum-free polymer dispersions having a high solids content and a low viscosity that dry/film with particular rapidity, this being manifested in the case of flooring adhesive formulations in the rapid onset of “stringing”.

The present invention provides an aqueous polymer dispersion derived from at least one ethylenically unsaturated monomer and with a solids content of at least 60% by weight, based on the polymer dispersion, comprising at least one salt of a phosphorus acid.

The present invention further provides a process for preparing aqueous polymer dispersions by emulsion polymerization, by subjecting at least one ethylenically unsaturated monomer to free-radical polymerization in aqueous phase in the presence of at least one emulsifier and of at least one initiator, which comprises carrying out the emulsion polymerization in the presence of at least one salt of a phosphorus acid.

The selection of the ethylenically unsaturated monomers suitable for preparing the polymer dispersions of the invention is in itself not critical. Suitable monomers are all those commonly used for preparing aqueous polymer dispersions and combinable with one another in a rational manner in accordance with the requirements of the art.

Typical ethylenically unsaturated monomers are vinyl esters of saturated carboxylic acids, esters, including monoesters, of ethylenically unsaturated carboxylic acids with saturated alcohols, ethylenically unsaturated aliphatic hydrocarbons or aromatic hydrocarbons containing ethylenically unsaturated radicals, ethylenically unsaturated ionic monomers, ethylenically unsaturated nonionic monomers, and further ethylenically unsaturated monomers of classes other than those mentioned above.

Preferred ethylenically unsaturated monomers are vinyl esters of carboxylic acids having 1 to 18 carbon atoms, esters, including monoesters, of ethylenically unsaturated C₃-C₈ monocarboxylic and dicarboxylic acids with saturated C₁-C₁₈ alkanols, aromatic or aliphatic ethylenically unsaturated hydrocarbons with or without halogen substitution or aromatic hydrocarbons containing ethylenically unsaturated radicals.

As vinyl esters of carboxylic acids having 1 to 18 carbon atoms it is possible to use all of the monomers known to the skilled worked.

Particular preference is given, however, to vinyl esters of carboxylic acids having 1 to 8 carbon atoms, such as vinyl formate, vinyl acetate, vinyl propionate, vinyl isobutyrate, vinyl pivalate, and vinyl-2-ethylhexanoate, for example; vinyl esters of saturated branched monocarboxylic acids having 9, 10 or 11 carbon atoms in the acid radical (®Versatic acids); vinyl esters of relatively long-chain, saturated and unsaturated fatty acids, examples being vinyl esters of fatty acids having 8 to 18 carbon atoms, such as vinyl laurate and vinyl stearate, for example; vinyl esters of benzoic acid or of p-tert-butylbenzoic acid, and mixtures thereof, such as mixtures of vinyl acetate and a Versatic acid or of vinyl acetate and vinyl laurate, for example. Particular preference is given to vinyl acetate.

As esters, including monoesters, of ethylenically unsaturated C₃-C₈ monocarboxylic and dicarboxylic acids with saturated C₁-C₁₈ alkanols it is possible to use all of the monomers known to the skilled worker.

Preference is given here to the esters and monoesters of ethylenically unsaturated C₃-C₈ monocarboxylic and dicarboxylic acids with C₁-C₁₂ alkanols, particular preference being given to esters and monoesters with C₁-C₈ alkanols or C₅-C₈ cycloalkanols. Examples of suitable C₁-C₁₈ alkanols include methanol, ethanol, n-propanol, isopropanol, 1-butanol, 2-butanol, isobutanol, tert.-butanol, n-hexanol, 2-ethylhexanol, lauryl alcohol and stearyl alcohol. Examples of suitable cycloalkanols include cyclopentanol and cyclohexanol.

Particular preference is given to the esters of acrylic acid, methacrylic acid, crotonic acid, maleic acid, itaconic acid and citraconic acid. A special preference is given to the esters of acrylic acid and/or of methacrylic acid, such as methyl (meth)acrylate, ethyl (meth)acrylate, isopropyl (meth)acrylate, n-butyl (meth)acrylate, isobutyl (meth)acrylate, 1-hexyl (meth)acrylate, tert-butyl (meth)acrylate, 2-ethylhexyl (meth)acrylate, and also the esters of maleic acid, such as dimethyl maleate, di-n-butyl maleate, di-n-octyl maleate and di-2-ethylhexyl maleate.

The esters stated may also be substituted by epoxy and/or hydroxyl groups if desired.

Preferred ethylenically unsaturated aliphatic hydrocarbons or aromatic hydrocarbons containing ethylenically unsaturated radicals are ethene, propene, 1-butene, 2-butene, isobutene, styrene, vinyltoluene, vinyl chloride and vinylidene chloride, with ethene and styrene being preferred.

Ethylenically unsaturated ionic monomers for the purposes of the present specification are those ethylenically unsaturated monomers which have a water-solubility of more than 50 g/l, preferably more than 80 g/l, at 25° C. and 1 bar and of which more than 50%, preferably more than 80%, is present in the form of an ionic compound in dilute aqueous solution at a pH of 2 and/or at a pH of 11, or else of which more than 50%, preferably more than 80%, is converted into an ionic compound at a pH of 2 and/or at a pH of 11 by protonization or deprotonization.

Examples of preferred ethylenically unsaturated ionic monomers are compounds which carry at least one carboxylic, sulfonic, phosphoric or phosphonic acid group directly adjacent to the double bond unit or are connected to said unit by way of a spacer group.

Examples that may be mentioned include the following: ethylenically unsaturated C₃-C₈ monocarboxylic acids and their anhydrides, ethylenically unsaturated C₅-C₈ dicarboxylic acids and their anhydrides, and monoesters of ethylenically unsaturated C₄-C₈ dicarboxylic acids.

Particular preference is given to unsaturated monocarboxylic acids, such as acrylic acid and methacrylic acid and their anhydrides; unsaturated dicarboxylic acids, such as maleic acid, itaconic acid and citraconic acid and their monoesters with C₁-C₁₂ alkanols, such as monomethyl maleinate and mono-n-butyl maleinate, for example.

Further preferred ethylenically unsaturated ionic monomers are ethylenically unsaturated sulfonic acids such as vinylsulfonic acid, 2-acrylamido-2-methylpropanesulfonic acid, 2-acryloyloxyethanesulfonic acid and 2-methacryloyloxyethanesulfonic acid, 3-acryloyloxysulfonic and 3-methacryloyloxypropanesulfonic acid, vinylbenzenesulfonic acid, and ethylenically unsaturated phosphonic acids, such as vinylphosphonic acid.

In addition to the stated acids it is also possible to employ their salts, preferably their alkali metal or ammonium salts and more preferably their sodium salts, such as the sodium salts of vinylsulfonic acid and of 2-acrylamidopropanesulfonic acid, for example.

The stated ethylenically unsaturated, free acids are predominantly in the form of their conjugate bases in anionic form in aqueous solution at a pH of 11 and, like the salts referred to, can be termed anionic monomers.

Ethylenically unsaturated nonionic monomers for the purposes of the present specification are those ethylenically unsaturated compounds which have a water-solubility of less than 80 g/l, preferably less than 50 g/l, at 25° C. and 1 bar and which are predominantly in nonionic form in dilute aqueous solution at a pH of 2 and at a pH of 11.

Preferred ethylenically unsaturated nonionic monomers are the amides of the carboxylic acids referred to in connection with the ethylenically unsaturated ionic monomers, such as methacrylamide and acrylamide, for example, and water-soluble N-vinyl lactams, such as N-vinylpyrrolidone, for example, and also ethylenically unsaturated compounds which contain covalently bonded polyethylene glycol units, such as polyethylene glycol monoallyl or diallyl ethers or the esters of ethylenically unsaturated carboxylic acids with polyalkylene glycols, for example.

Suitable further ethylenically unsaturated monomers which do not fall into one of the abovementioned classes include siloxane-functional monomers of the general formula RSi(CH₃)₀₋₂(OR¹)₃₋₁, where R has the definition CH₂═CR²—(CH₂)₀₋₁ or CH₂═CR²CO₂—(CH₂)₁₋₃, R¹ is an unbranched or branched, unsubstituted or substituted alkyl radical having 3 to 12 carbon atoms, which if desired may be interrupted by an ether group, and R² is H or CH₃.

Additional suitable further ethylenically unsaturated monomers which do not-fall into one of the abovementioned classes include nitriles of ethylenically unsaturated C₃-C₈ carboxylic acids, such as acrylonitrile and methacrylonitrile, and also adhesion-promoting monomers and crosslinking monomers. C₄-C₈ conjugated dienes as well, such as 1,3-butadiene, isoprene and chloroprene, for example, can be used as ethylenically unsaturated monomers.

The adhesion-promoting monomers include not only compounds containing an acetoacetoxy unit bonded covalently to the double bond system but also compounds containing covalently bonded urea groups.

The adhesion-promoting monomers can be used if desired in amounts of from 0.1% to 10% by weight, preferably from 0.5% to 5% by weight, based on the total amount of the monomers.

As crosslinking monomers both difunctional and polyfunctional monomers can be used. Examples thereof include diallyl phthalate, diallyl maleate, triallyl cyanurate, tetraallyloxyethane, divinylbenzene, butane-1,4-diol di(meth)acrylate, triethylene glycol di(meth)acrylate, divinyl adipate, allyl (meth)acrylate, vinyl crotonate, methylenebisacrylamide, hexanediol di(meth)acrylate, pentaerythritol di(meth)acrylate and trimethylolpropane tri(meth)acrylate.

The crosslinking monomers can be used if desired in amounts of from 0.02% to 5% by weight, preferably from 0.02% to 1% by weight, based on the total amount of the monomers.

Selection of the suitable monomers or monomer combinations must take account of the generally recognized aspects relating to the preparation of aqueous dispersions. Thus in particular it must be ensured that the selection of the monomers for preparing copolymers is made such that the formation of copolymers is likely in accordance with the position of the polymerization parameters.

Preferred ethylenically unsaturated principal monomers are esters of acrylic acid and/or of methacrylic acid with primary and secondary saturated monovalent alcohols having 1 to 18 carbon atoms; for example, with methanol, ethanol, propanol, butanol and 2-ethylhexyl alcohol, with cycloaliphatic alcohols and with relatively long-chain fatty alcohols.

Further preferred ethylenically unsaturated monomers that are used in combination with the monomers described above include α,β-unsaturated dicarboxylic acids, such as maleic acid, itaconic acid or citraconic acid, and their monoesters or diesters with saturated monovalent aliphatic alcohols having 1 to 18 carbon atoms.

As a proportion of the total monomer amount the fraction of these comonomers is normally up to 20% by weight, preferably up to 10% by weight, based on the total amount of the monomers employed.

Further ethylenically unsaturated monomers used with preference are vinyl esters of saturated fatty acids having one to eight carbon atoms, such as vinyl formate, vinyl acetate, vinyl propionate, vinyl isobutyrate, vinyl pivalate, and vinyl 2-ethylhexanoate; vinyl esters of saturated branched monocarboxylic acids having nine or ten carbon atoms, vinyl esters of saturated or unsaturated fatty acids having ten to twenty carbon atoms, such as vinyl laurate and vinyl stearate; and also vinyl esters of benzoic acid and of substituted derivatives of benzoic acid, such as vinyl p-tert-butylbenzoate. Particular preference is given to vinyl acetate.

The stated vinyl esters may also be present alongside one another in the polymer. The fraction of these vinyl esters in the polymer is generally at least 50% by weight, preferably at least 80% by weight.

Further preferred comonomers are a-olefins having two to eighteen carbon atoms, examples being ethylene, propylene or butylene, and also aromatic hydrocarbons containing a vinyl radical, such as styrene, vinyltoluene and vinylxylene, and also halogenated unsaturated aliphatic hydrocarbons, such as vinyl chloride, vinyl fluoride, vinylidene chloride and vinylidene fluoride.

As a proportion of the total monomer amount the fraction of these comonomers is up to 50% by weight, preferably up to 20% by weight.

Further preferred comonomers are polyethylenically unsaturated monomers, such as diallyl phthalate, diallyl maleinate, triallyl cyanurate, tetraallyloxyethane, divinylbenzene, butane-1,4-diol dimethacrylate, triethylene glycol dimethacrylate, divinyl adipate, allyl (meth)acrylate, vinyl crotonate, methylenebis(meth)acrylamide, hexanediol di(meth)acrylate, pentaerythritol di(meth)acrylate and trimethylolpropane tri(meth)acrylate.

As a proportion of the total monomer amount the fraction of these comonomers is generally up to 5% by weight, preferably from 2 to 4% by weight.

Particular suitability attaches to using comonomers containing N-functional groups, including in particular (meth)acrylamide, allyl carbamate, acrylonitrile, N-methylol(meth)acrylamide, N-methylolallyl carbamate and also the N-methylol esters, alkyl ethers or Mannich bases of N-methylol(meth)acrylamide or of N-methylolallyl carbamate, acrylamidoglycolic acid, methylacrylamidomethoxy acetate, N-(2,2-dimethoxy-1-hydroxyethyl)acrylamide, N-dimethylaminopropyl(meth)acrylamide, N-methyl(meth)acrylamide, N-butyl(meth)acrylamide, N-cyclohexyl(meth)acrylamide, N-dodecyl(meth)-acrylamide, N-benzyl(meth)acrylamide, p-hydroxyphenyl(meth)acrylamide, N-(3-hydroxy-2,2-dimethylpropyl)methacrylamide, ethyl imidazolidonemethacrylate, N-vinylformamide and N-vinylpyrrolidone.

As a proportion of the total monomer amount the fraction of these comonomers is generally up to 5% by weight, preferably from 2 to 4% by weight.

Comonomers which are also particularly suitable are hydroxy-functional monomers such as hydroxyethyl(meth)acrylate, hydroxypropyl(meth)acrylate and the adducts thereof with ethylene oxide or propylene oxide.

As a proportion of the total monomer amount the fraction of these comonomers is generally up to 5% by weight, preferably from 2 to 4% by weight.

Particular suitability attaches, furthermore, to comonomers which can be crosslinked by way of carbonyl groups or are self-crosslinking, from the group consisting of diacetoneacrylamide, allyl acetoacetate, vinyl acetoacetate and acetoacetoxyethyl(meth)acrylate.

As a proportion of the total monomer amount the fraction of these comonomers is generally up to 5% by weight, preferably from 2 to 4% by weight.

The chosen amount of the ethylenically unsaturated monomers or monomer combinations used in the process of the invention is to be such that the target solids content of the aqueous dispersion can be achieved. The total amount of monomer can be introduced right at the beginning of the emulsion polymerization or, preferably, a small amount of the monomer is introduced initially and the remainder is added in one or more steps, with particular preference continuously, after the polymerization has been initiated.

The mass of the ethylenically unsaturated monomers employed, based on the total mass of the dispersion, is preferably at least 65% by weight, in particular from 65% to 75% by weight.

The polymerization of the ethylenically unsaturated monomers in accordance with the invention takes place in the presence of at least one emulsifier for the ethylenically unsaturated monomer. The emulsifiers in question may be nonionic and/or ionic emulsifiers.

Suitable nonionic emulsifiers are araliphatic and aliphatic nonionic emulsifiers, such as ethoxylated mono-, di- and trialkylphenols (EO units: 3 to 50, alkyl radical: C₄ to C₉), ethoxylates of long-chain alcohols (EO units: 3 to 50, alkyl radical: C₈ to C₃₆), and also polyethylene oxide/polypropylene oxide block copolymers.

Preference is given to ethoxylates of long-chain alkanols (alkyl radical: C₁₀ to C₂₂, mean degree of ethoxylation: 3 to 50) and, of these, particular preference to those based on naturally occurring alcohols, Guerbet alcohols or oxo alcohols, having a linear or branched C₁₂-C₁₈ alkyl radical and a degree of ethoxylation of from 8 to 50.

Further suitable emulsifiers are found in Houben-Weyl, Methoden der organischen Chemie, Vol. XIV/I, Makromolekulare Stoffe [Macromolecular compounds], Georg-Thieme-Verlag, Stuttgart, 1961, pp. 192-208.

The anionic emulsifiers include alkali metal and ammonium salts of alkyl sulfates (alkyl radical: C₈ to C₁₈), alkylphosphonates (alkyl radical: C₈ to C₁₈), of sulfuric monoesters or phosphoric monoesters and diesters with ethoxylated alkanols (EO units: 2 to 50, alkyl radical: C₈ to C₂₂) and with ethoxylated alkylphenols (EO units: 3 to 50, alkyl radical: C₄ to C₉), of alkyl sulfonic acids (alkyl radical: C₁₂ to C₁₈), of alkylaryl sulfonic acids (alkyl radical: C₉ to C₁₈), of sulfosuccinate monoesters and sulfosuccinate diesters of alkanols (alkyl radical: C₈ to C₂₂) and ethoxylated alkanols (EO units: 2 to 50, alkyl radical: C₈ to C₂₂), and with nonethoxylated and ethoxylated alkyl phenols (EO units: 3 to 50, alkyl radical: C₄ to C₉).

The emulsifiers listed are generally employed in the form of technical-grade mixtures, the indications given of length of alkyl radical and EO chain referring to the respective maximum of the distributions occurring in the mixtures.

Examples from the stated classes of emulsifiers are ®Texapon K12 (sodium lauryl sulfate from Cognis), ®Emulsogen EP (C₁₃-C₁₇ alkylsulfonate from Clariant), ®Maranil A 25 IS (sodium n-alkyl(C₁₀-C₁₃)-benzenesulfonate from Cognis), ®Genapol liquid ZRO (sodium C₁₂/C₁₄ alkyl ether sulfate with 3 EO units from Clariant), ®Hostapal BVQ-4 (sodium salt of a nonylphenol ether sulfate with 4 EO units from Clariant), Aerosol MA 80 (sodium dihexylsulfosuccinate from Cytec Industries), Aerosol A-268 (disodium isodecylsulfosuccinate from Cytec Industries) and Aerosol A-103 (disodium salt of a monoester of sulfosuccinic acid with an ethoxylated nonylphenol from Cytec Industries).

In addition it is possible to use not only ionic but also nonionic emulsifiers which as additional functionality contain one or more unsaturated double bond units and which during the polymerization process can be incorporated into the polymer chains which form. These compounds, termed copolymerizable emulsifiers (“surfmers”), are common knowledge to the skilled worker. Examples can be found in a series of publications (e.g.: “reactive surfactants in heterophase polymerization” by A. Guyot et al. in Acta Polym. 1999, pp.57-66) and are available commercially (e.g. ®Emulsogen R 208 from Clariant or Trem LF 40 from Cognis).

The amounts of the emulsifiers used are within the limits normally to be observed.

In general up to about 10% by weight, preferably up to 5% by weight, based on the total amount of the monomers used for preparing the dispersions, are used.

The total amount of emulsifier may be introduced right at the beginning of the emulsion polymerization or, preferably, some of the emulsifier is introduced at the beginning and the remainder is added in one or more steps, or continuously, after the polymerization has been initiated. Emulsifier can be added separately or together with other components, such as monomers and/or initiators.

The polymerization of the ethylenically unsaturated monomers according to the invention takes place in the presence of at least one initiator for the free-radical polymerization of the ethylenically unsaturated monomer or monomers. Suitable initiators for free-radical polymerization for initiating and continuing the polymerization during the preparation of the dispersions include all known initiators capable of initiating a free-radical aqueous emulsion polymerization.

The initiators may be peroxides, such as alkali metal peroxodisulfates, or azo compounds.

As polymerization initiators it is also possible to use what are called redox initiators, which are composed of at least one organic and/or inorganic reducing agent and of at least one peroxide and/or hydroperoxide, such as, for example, tert-butyl hydroperoxide with sulfur compounds, such as the sodium salt of hydroxy methane sulfinic acid, sodium sulfite, sodium disulfite, sodium thiosulfate and acetone-bisulfite adduct, or hydrogen peroxide with ascorbic acid, or combinations of sulfur compounds such as Brüggolites® FF07 and FF06; as further reducing agents which form free radicals with peroxides it is also possible to use reducing sugars.

It is also possible to use combined systems which contain a small amount of a metal compound which is soluble in the polymerization medium and whose metallic component is able to exist in a plurality of valence-states, such as, for example, ascorbic acid/iron(II) sulfate/hydrogen peroxide, the ascorbic acid also being frequently replaced by the sodium salt of hydroxy methane sulfinic acid, acetone-bisulfite adduct, sodium sulfite, sodium hydrogen sulfite or sodium bisulfite, and the hydrogen peroxide by organic peroxides such as tert-butylhydroperoxide or alkali metal peroxodisulfates and/or ammonium peroxodisulfate. Instead of said acetone-bisulfite adduct it is also possible to employ further bisulfite adducts known to the skilled worker, such as those described in EP-A-778,290 for example, and in the references cited therein.

Further preferred initiators are peroxodisulfates, such as sodium peroxodisulfate.

The amount of initiators or initiator combinations used in the process of the invention is within the bounds of what is usual for aqueous emulsion polymerizations. In general the amount of initiator used will not exceed 2% by weight, based on the total amount of the monomers to be polymerized.

The amount of the initiators used, based on the total amount of the monomers to be polymerized, is preferably from 0.05% to 1% by weight.

The total amount of initiator can be introduced right at the beginning of the emulsion polymerization or,. preferably, some of the initiator is introduced at the beginning and the remainder is added in one or more steps or continuously after the polymerization has been initiated. Initiator can be added separately or together with other components, such as monomers and/or emulsifiers.

The emulsion polymerization of the ethylenically unsaturated monomers takes place in the presence of at least one salt of a phosphorus acid.

For the purposes of this description this is a reference to salts which derive from any desired phosphorus acid, such as phosphorous acid, phosphonic acid, phosphinic acid or, with particular preference, phosphoric acid.

The salts used in accordance with the invention are water-soluble. For the purposes of this description these are salts which are soluble in water to an extent of at least 10 g/l at 25° C.

In accordance with the invention it is preferred to use any desired phosphates provided that they are water-soluble. The phosphates in question can therefore be monophosphates or polyphosphates in linear or cyclic form (=metaphosphates). It is also possible to use condensed phosphates, which may be branched or crosslinked.

As counterions of the water-soluble salts of phosphorus acids that are used in accordance with the invention it is possible to employ any desired cations, provided the salts are water-soluble. Examples are alkali metal or alkaline earth metal cations or ammonium or phosphonium cations.

Sodium, potassium and ammonium salts are preferred.

Examples of salts of phosphorus acids used with preference are sodium monophosphates, such as monosodium dihydrogen monophosphate, disodium hydrogen monophosphate or trisodium monophosphate and also disodium dihydrogen phosphate, tetrasodium diphosphate, pentasodium triphosphate, or sodium polyphosphates with higher degrees of condensation, such as Madrell's salt, Graham's salt or Kurrol's salt, and also sodium trimetaphosphate and sodium hexametaphosphate or the corresponding ammonium salts of these phosphates.

Salts of phosphorus acids used with preference are water-soluble phosphates, including the hydrogen phosphates.

Examples thereof are water-soluble ammonium, alkali metal or alkaline earth metal phosphates and also the corresponding hydrogen phosphates.

The chosen amount of the salts of a phosphorus acid or combinations thereof used in accordance with the invention is such that the target solids content can be achieved. Generally speaking, the amount of the salts of phosphorus acids used will not exceed 5% by weight, based on the total amount of the monomers to be polymerized.

The amounts of the salts of phosphorus acids used, based on the total amount of the monomers to be polymerized, is preferably from 0.1% to 2% by weight.

The total amount of salt of phosphorus acids can be introduced right at the beginning of the emulsion polymerization or a portion of the salt of phosphorus acids is introduced at the beginning and the remainder is added in one or more steps or continuously after the polymerization has been initiated. The salt of phosphorus acids can be added separately or together with other components, such as monomers and/or emulsifiers and/or initiators.

In the process of the invention it is possible to use not only emulsifiers but also, if desired, protective colloids. The protective colloids are polymeric compounds generally having molecular weights of more than 2000 g/mol, whereas the emulsifiers are low molecular weight compounds whose relative molecular weights are generally below 2000 g/mol.

Examples of protective colloids include natural polymeric materials, such as starch, gum arabic, alginates or tragacanth; modified polymeric natural materials, such as methyl-, ethyl-, hydroxyethyl- or carboxymethylcellulose or starch modified by means of saturated acids or epoxides; synthetic polymeric substances such as polyvinyl alcohol (with or without residual acetyl content) or polyvinyl alcohol which has been partly esterified or acetalized or etherified with saturated radicals; and also polypeptides, such as gelatin, but also polyvinylpyrrolidone, polyvinylmethylacetamide or poly(meth)acrylic acid.

The weight fraction of such protective colloids, where present, based on the total amount of the monomers used for the preparation, is normally up to 10%.

The molecular weight of the homopolymers and/or copolymers of the aqueous dispersions can be adjusted by adding small amounts of one or more molecular weight regulator substances. These regulators, as they are known, are used generally in an amount of up to 2% by weight, based on the monomers to be polymerized. As regulators it is possible to use any substances known to the skilled worker. Preference is given, for example, to organic thio compounds, silanes, allyl alcohols and aldehydes.

The aqueous dispersion may further comprise a series of additional substances, such as plasticizers, preservatives, pH modifiers and/or defoamers, for example.

The process of the invention can be carried out in a wide variety of ways. For instance, the emulsion polymerization may take place either in batch mode or else, preferably, by continuous or semibatch processes.

In the case of the semibatch processes the major amount, for example at least 70% by weight, preferably at least 90% by weight, of the monomers to be polymerized is supplied to the polymerization batch continuously, including by staged or gradient procedures. This procedure is also referred to as the monomer feed technique, a phrase in which monomer feed refers to the metered addition of gaseous monomers, liquid monomer (mixtures), monomer solutions or, in particular, aqueous monomer emulsions.

The metered addition of the individual monomers may take place through separate feeds. In addition it is of course also possible to carry out the metering of the monomers in such a way that the mixture of the metered monomer compositions is varied such that the resulting polymer has different polymer phases, which is manifested, for example, in the occurrence of more than one glass transition temperature when the dry polymer is analyzed by means of differential scanning calorimetry (DSC).

The polymerization temperature is within the ranges known for aqueous emulsion polymerizations. Temperatures between 25 and 100° C. are typically chosen.

Following the actual polymerization reaction it may be desirable and/or necessary substantially to free the resultant aqueous polymer dispersion from odoriferous substances, such as residual monomers and other volatile organic constituents, for example. This can be done in conventional manner physically, for example, by distillative removal (in particular by steam distillation) or by stripping with an inert gas. The reduction in the amount of residual monomers can also be accomplished chemically by means of free-radical postpolymerization, in particular under the action of redox initiator systems, as are described, for example, in DE-A-4,435,423.

The aqueous dispersions of the invention may comprise further ingredients, whose selection is guided by the desired field of use in each case.

Examples of further ingredients are rheology modifier additives, defoamers, antislip additives, color pigments, antimicrobial preservatives, plasticizers, film-forming auxiliaries and matting agents.

With the process of the invention it is possible to prepare aqueous polymer dispersions having a high solids content. These dispersions are distinguished by a surprisingly low viscosity and hence by good processing properties.

Typical solids contents are at least 60% by weight, based on the polymer dispersion.

Preferred polymer dispersions have solids contents of at least 70% by weight, in particular from 70% to 75% by weight.

Typical dynamic viscosities at solids contents of 60% by weight are below 3000 mPa*sec, measured at 25° C. using a Brookfield viscometer (spindle #5, 20 revolutions/minute).

Typical dynamic viscosities at solids contents of 65% by weight are below 8000 mPa*sec, measured at 25° C. using a Brookfield viscometer (spindle #5, 20 revolutions/minute).

Typical dynamic viscosities at solids contents of 70% by weight are below 15 000 mPa*sec, measured at 25° C. using a Brookfield viscometer (spindle #5, 20 revolutions/minute).

Particularly preferred polymer dispersions of the invention have solids contents of more than 70% by weight and at the same time have low viscosities of this order.

The particle size distributions of the dispersions of the invention are at least trimodal, although their modalities may also be even higher.

The dispersions of the invention generally possess average particle diameters in the range between 40 and 1000 nm.

The dispersions of the invention can be employed in adhesive formulations and also in building materials, such as in joint-sealing compounds and flooring adhesives, for example.

These uses are likewise provided for by the present invention.

The invention is illustrated by the examples below. No restriction is intended thereby.

### EXAMPLE 1

A 3-liter reactor equipped with a reflux condenser and anchor stirrer was charged with 268.38 g of demineralized water (DI water below) and 8.68 g of disodium hydrogen phosphate×12 H₂O and this initial charge was heated to 75° C. with stirring (speed: 80 rpm). At this temperature 48.35 g of monomer emulsion according to the table below and the initiator, 1.05 g of ammonium persulfate (APS) in solution in 9.45 g of DI water, were introduced into the reactor in order to initiate the polymerization. 20 minutes after the initiation of polymerization the metered addition of the monomer emulsion was commenced from a separate vessel. The metering time was 4.5 hours.

TABLE
Composition of the monomer emulsion (amounts in grams)

| | |
|---|---|
| DI water | 238 |
| C₁₁ alkyl ethoxylate containing 20 mol EO (70%) | 15.20 |
| C₁₁ alkyl ether sulfate containing 7 mol EO (28%) | 65.50 |
| Methacrylic acid | 14.00 |
| Acrylic acid | 11.20 |
| Acetoacetoxyethyl methacrylate | 28.00 |
| Potassium persulfate | 4.20 |
| Butyl acrylate | 840.0 |
| Methyl methacrylate | 252.0 |
| 2-Ethylhexyl acrylate | 308.0 |
| n-Dodecanethiol | 1.40 |

Following the metered addition a further 1.05 g of APS in 9.45 g of DI water were added, after 30 minutes 25.20 g of ammonia (12.5%) were added dropwise, followed by stirring at 75° C. for 2 hours more. The batch was cooled to 50° C. and reducing agent mixture 1 was added according to the table below. After a further 20 minutes of stirring reducing agent mixture 2 was added and stirring was continued for 20 minutes. Thereafter the product was cooled.

Composition of reducing agent mixtures 1 and 2
(amounts in grams)

| | |
|---|---|
| tert-Butyl hydroperoxide (70% strength) | 0.50 |
| DI water | 3.15 |
| Na₂S₂O₅ | 0.18 |
| DI water | 3.15 |

The dispersion obtainable by the process described was free from specks, had a solids content of 71% by weight and possessed good processing properties.

The measurement of the particle size distribution by means of high-resolution analytical ultracentrifuge (AUC) showed in respect of the mass distribution d_{w} three separate particle populations, with a ratio ideal for close packing.

Particles having an average diameter of 457 nm were found with a fraction of 76%, particles having an average diameter of 167 nm with a fraction of 19%, and the smallest particles, having an average diameter of 47 nm, at 5% in the sample.

The viscosity, measured at 25° C. using a Brookfield viscometer, spindle number 5, at 20 rpm, was 13 300 mPas.

The glass transition temperature T_{g} (measured by the DSC method) was −30° C.

### EXAMPLE 2

A 3-liter reactor equipped with a reflux condenser and anchor stirrer was charged with 249.21 g of demineralized water and 8.06 g of disodium hydrogen phosphate×12 H₂O and this initial charge was heated to 75° C. with stirring (speed: 80 rpm). At this temperature 46.66 g of monomer emulsion according to the table below and the initiator, 0.98 g of APS in solution in 8.78 g of DI water, were introduced into the reactor in order to initiate the polymerization. 20 minutes after the initiation of polymerization the metered addition of the monomer emulsion was commenced from a separate vessel. The metering time was 4.5 hours.

TABLE
Composition of the monomer emulsion (amounts in grams)

| | |
|---|---|
| DI water | 286.00 |
| C₁₁ alkyl ethoxylate containing 20 mol EO (70%) | 14.11 |
| C₁₁ alkyl ether sulfate containing 7 mol EO (28%) | 16.82 |
| Methacrylic acid | 13.00 |
| Acrylic acid | 10.40 |
| Acetoacetoxyethyl methacrylate | 26.00 |
| Potassium persulfate | 3.90 |
| Butyl acrylate | 780.0 |
| Methyl methacrylate | 234.0 |
| 2-Ethylhexyl acrylate | 286.0 |
| n-Dodecanethiol | 1.30 |

Following the metered addition a further 0.98 g of APS in 8.78 g of water were added. After 30 minutes 23.40 g of ammonia (12.5% strength) were added dropwise, followed by stirring at 75° C. for 2 hours more. The batch was cooled to 50° C. and reducing agent mixture 1 was added according to the table below. After a further 20 minutes of stirring reducing agent mixture 2 was added and stirring was continued for 20 minutes. Thereafter the product was cooled.

TABLE
Composition of reducing agent mixtures 1 and 2 (amounts in grams)

| | |
|---|---|
| tert-Butyl hydroperoxide (70% strength) | 0.46 |
| DI water | 2.93 |
| Na₂S₂O₅ | 0.17 |
| DI water | 2.93 |

The dispersion obtained by the process described was free from specks, had a solids content of 67.5% and possessed good processing properties.

The viscosity, measured at 25° C. using a Brookfield viscometer, spindle number 5, at 20 rpm, was 7500 mPas.

The glass transition temperature T_{g} (measured by the DSC method) was −30° C.

### USE EXAMPLES

The dispersions from examples 1 and 2 were tested for their usefulness as binders for producing flooring adhesives. In spite of the high solids contents the dispersions were easy to handle and were readily modified to form flooring adhesives having good processing properties.

The resin compatibility and filler compatibility were tested in storage tests and gave no cause for complaint.

The flooring adhesive formula used was as follows:

| | |
|---|---|
| 35.0% by weight | the respective dispersion |
| 10.0% by weight | water |
| 0.2% by weight | defoamer (Agitan 305) |
| 0.2% by weight | preservative (Mergal K11) |
| 0.5% by weight | dispersant (polyacrylate) |
| 1.2% by weight | dispersant and wetting agent (polyphosphate) |
| 20.0% by weight | filler Omyacarb 10 BG |
| 20.0% by weight | filler Omyacarb 20 BG |
| 20.0% by weight | a mixture of rosin, Alresat KE 300 and |
| | butyl diglycol acetate |
| 0.2% by weight | thickener (cellulose ether) |

Testing of the laying times and wet tack in a standard flooring adhesive formula

| | Example | | Example | | Comparative | |
|---|---|---|---|---|---|---|
| | dispersion 1 | | dispersion 2 | | example 3 | |
| | Bond | | Bond | | Bond | |
| Time | strength | Wetting | strength | Wetting | strength | Wetting |
| [min.] | [g] | [%] | [g] | [%] | [g] | [%] |
| 10 | 200 | 100 | 200 | 100 | 150 | 100 |
| 20 | 1000 | 100 | 800 | 100 | 550 | 100 |
| 30 | 2200 | 100 | 1400 | 100 | 800 | 100 |
| 40 | 4800 | 10 | 4300 | 80 | 2400 | 100 |
| 50 | — | — | 3500 | 0 | 2500 | 0 |
| Afterwet. | 4500 | 0 | 4500 | 0 | 3500 | 0 |

Just 40 minutes following application of the adhesive a wet tack bond strength of >=4300 g/5 cm floor covering width was measured. This guarantees that even floor coverings with a high resilience can be held on the floor.

### EXAMPLE 3

### Comparative

The polymerization was carried out in the same way as in example 1 but without disodium hydrogen phosphate×12 H₂O in the initial charge. An extreme increase in viscosity was found, with coagulation of the batch.

### EXAMPLE 4

### Comparative

A 3-liter reactor equipped with a reflux condenser and anchor stirrer was charged with 210.87 g of demineralized water and this initial charge was heated to 75° C. with stirring (speed: 80 rpm). At this temperature 50.25 g of monomer emulsion and the initiator, 0.83 g of APS in solution in 7.43 g of DI water, were introduced into the reactor in order to initiate the polymerization. 20 minutes after the initiation of polymerization the metered addition of the monomer emulsion was commenced from a separate vessel according to the table below. The metering time was 4.5 hours.

TABLE
Composition of the monomer emulsion (amounts in grams)

| | |
|---|---|
| DI water | 638.00 |
| C₁₁ alkyl ethoxylate containing 20 mol EO (70%) | 11.94 |
| C₁₁ alkyl ether sulfate containing 7 mol EO (28%) | 51.46 |
| Methacrylic acid | 11.00 |
| Acrylic acid | 8.80 |
| Acetoacetoxyethyl methacrylate | 22.00 |
| Potassium persulfate | 3.30 |
| Butyl acrylate | 660.0 |
| Methyl methacrylate | 198.0 |
| 2-Ethylhexyl acrylate | 242.0 |
| n-Dodecanethiol | 1.10 |

Following the metered addition a further 0.83 g of APS in 7.43 g of water was added. After 30 minutes 19.8 g of ammonia (12.5% strength) were added dropwise, followed by stirring at 75° C. for 2 hours more. The batch was cooled to 50° C. and reducing agent mixture 1 was added according to the table below. After a further 20 minutes of stirring reducing agent mixture 2 was added and stirring was continued for 20 minutes. Thereafter the product was cooled.

TABLE
Composition of reducing agent mixtures 1 and 2 (amounts in grams)

| | |
|---|---|
| tert-Butyl hydroperoxide (70% strength) | 0.39 |
| DI water | 2.48 |
| Na₂S₂O₅ | 0.14 |
| DI water | 2.48 |

This dispersion showed no multimodality in its particle size distribution.

1. An aqueous polymer dispersion derived from at least one ethylenically unsaturated monomer and with a solids content of at least 60% by weight, based on the polymer dispersion, comprising at least one salt of a phosphorus acid:

2. The aqueous polymer dispersion as claimed in claim 1, wherein said ethylenically unsaturated monomers include vinyl esters of carboxylic acids having 1 to 18 carbon atoms, esters, monoesters of ethylenically unsaturated C₃-C₈ monocarboxylic, dicarboxylic acids with saturated C₁-C₁₈ alkanols, aromatic or aliphatic ethylenically unsaturated hydrocarbons with or without halogen substitution or aromatic hydrocarbons containing ethylenically unsaturated radicals.

3. The aqueous polymer dispersion as claimed in claim 1, wherein ethylenically unsaturated principal monomers used include esters of acrylic acid and/or of methacrylic acid with primary and secondary saturated monovalent alcohols having 1 to 18 carbon atoms.

4. The aqueous polymer dispersion as claimed in claim 2 wherein said ethylenically unsaturated monomers further include α,β-unsaturated dicarboxylic acids, and their monoesters or diesters with saturated monovalent aliphatic alcohols having 1 to 18 carbon atoms.

5. The aqueous polymer dispersion as claimed in claim 1, wherein said ethylenically unsaturated principal monomers include vinyl esters of saturated fatty acids having one to eight carbon atoms, vinyl esters of saturated branched monocarboxylic acids having nine or ten carbon atoms, vinyl esters of saturated or unsaturated fatty acids having ten to twenty carbon atoms, or vinyl esters of benzoic acid and of substituted derivatives of benzoic acid.

6. The aqueous polymer dispersion as claimed in claim 1, wherein the solids content is from 65% to 75% by weight, based on the total mass of the polymer dispersion.

7. The aqueous polymer dispersion as claimed in claim 1, comprising nonionic and/or anionic emulsifiers.

8. The aqueous polymer dispersion as claimed in claim 1, comprising at least one water-soluble sodium, potassium or ammonium salt of a phosphorus acid.

9. The aqueous polymer dispersion as claimed in claim 8, wherein the water-soluble salt of a phosphorus acid is selected from the group consisting of sodium monophosphates, disodium dihydrogen phosphate, tetrasodium diphosphate, pentasodium triphosphate sodium polyphosphates with higher degrees of condensation, sodium trimetaphosphate and sodium hexametaphosphate, the corresponding ammonium salts of these phosphates, and combinations of two or more of these compounds.

10. The aqueous polymer dispersion as claimed in claim I, whose particle size distribution is at least trimodal.

11. The aqueous polymer dispersion as claimed in claim 1, having a solids content of at least 60% by weight and possessing a dynamic viscosity of below 3000 mPa*sec, measured at 25° C.

12. The aqueous polymer dispersion as claimed in claim 1, having a solids content of at least 65% by weight and possessing a dynamic viscosity of below 8000 mPa*sec, measured at 25° C.

13. The aqueous polymer dispersion as claimed in claim 1, having a solids content of at least 70% by weight and possessing a dynamic viscosity of below 15 000 mPa*sec, measured at 25° C.

14. A process for preparing an aqueous polymer dispersion by emulsion polymerization comprising subjecting at least one ethylenically unsaturated monomer to free-radical polymerization in aqueous phase in the presence of at least one emulsifier and of at least one initiator, and carrying out the emulsion polymerization in the presence of at least one salt of a phosphorus acid.

15. The process as claimed in claim 14, wherein the polymerization takes place at temperatures between about 25 and about 100° C.

16. The process as claimed in claim 14, wherein the polymerization is carried out in the presence of anionic and/or nonionic emulsifiers.

17. The process as claimed in claim 14, wherein the polymerization is carried out in the presence of at least one protective colloid.

18. (Canceled)

19. The aqueous polymer dispersion as claimed in claim 4 wherein said α,β-unsaturated dicarboxylic acids are maleic acid, itaconic acid or citraconic acid, and their monoesters or diesters.

20. The aqueous polymer dispersion as claimed in claim 5 wherein said ethylenically unsaturated principal monomers are vinyl esters of saturated fatty acids having one to eight carbon atoms, selected from the group consisting of vinyl formate, vinyl acetate, vinyl propionate, vinyl isobutyrate, vinyl pivalate, and vinyl-2-ethylhexanoate.

21. The aqueous polymer dispersion as claimed in claim 5 further comprising α-olefins having two to eighteen carbon atoms.

22. The aqueous polymer dispersion as claimed in claim 21 wherein said α-olefins having two to eighteen carbon atoms are ethylene, propylene, butylene or a combination thereof.

23. The aqueous polymer dispersion as claimed in claim 5 further comprising an aromatic hydrocarbon containing a vinyl radical.

24. The aqueous polymer dispersion as claimed in claim 23 wherein said aromatic hydrocarbon containing a vinyl radical is selected from the group consisting of styrene, vinyltoluene and vinylxylene.

25. The aqueous polymer dispersion as claimed in claim 5 further comprising halogenated unsaturated aliphatic hydrocarbons.

26. The aqueous polymer dispersion as claimed in claim 25 wherein said halogentated unsaturated aliphatic hydrocarbons are selected from the group consisting of vinyl chloride, vinyl fluoride, vinylidene chloride and vinylidene fluoride or a combination thereof.

27. The aqueous polymer dispersion as claimed in claim 9, wherein said water soluble salt of a phosphourus acid is a sodium monophosphate selected from the group consisting of monosodium dihydrogen monophosphate, disodium hydrogen monophosphate and trisodium monophosphate.

28. The aqueous polymer dispersion as claimed in claim 9, wherein said water soluble salt of a phosphorus acid is a sodium polyphosphate selected from the group consisting of Madrell's salt, Graham's salt or Kurrol's salt.
